(19) United States
(12) Patent Application Publication
(10) Pub. No.: US 2017/0348657 A1
(43) Pub. Date: Dec. 7, 2017

(54) Dry Powder Blending

(71) Applicant: Halliburton Energy Services, Inc., Houston, TX (US)

(72) Inventors: Danny Keith Mints, Duncan, OK (US); Rickey Lynn Morgan, Duncan, OK (US); Paul Lewis Mendenall, Duncan, OK (US)

(21) Appl. No.: 15/536,532

(22) PCT Filed: Jan. 20, 2015
(86) PCT No.: PCT/US2015/011964

§ 371 Date: Jun. 15, 2017

(51) Int. Cl. B01F 15/02; B01F 7/00; B01F 15/04; B01F 3/18; E21B 33/13; B28C 5/12

(52) U.S. Cl. CPC B01F 15/0258; E21B 33/13; B28C 5/123; B01F 15/0425; B01F 3/18; B01F 15/0251; B01F 7/00633; B01F 15/0408

(57) ABSTRACT

A system can include a dry powder mixing tank, a first powder input, a second powder input, a powder output, and a detection device. The first powder input and the second powder input can introduce powders containing different substances that become mixed in the dry powder mixing tank. The detection device can detect information about amounts of different substances in a blend of powder moved out of the tank by the powder output. In some aspects, portions of the blend that do not satisfy parameters for the blend can be diverted from a receptacle for the blend based on the detected information.

### TECHNICAL FIELD

The present disclosure relates generally to producing cement and, more particularly (although not necessarily exclusively), to mixing batches of dry powder cement suitable for oilfield cementing operations.

### BACKGROUND

Cementing operations—such as those used in preparing or maintaining well assemblies traversing a hydrocarbon-bearing subterranean formation—can use many varieties of cement blends. Different combinations of chemical additives can be mixed with “neat cement” (e.g., cement free of previously added chemical additives) to form a cement blend and adjust characteristics such as density, setting time, strength, elasticity, plasticity, viscosity, and flow properties of the resulting cement. Yet, additives that are not distributed evenly throughout a cement blend can cause different portions of the cement blend to exhibit different characteristics during cementing operations. Such inconsistent or unpredictable performance of an unevenly mixed cement blend can result in increased costs, decreased safety, or other adverse effects on a cementing operation.

### BRIEF DESCRIPTION OF THE DRAWINGS

FIG. 1 is a schematic illustration of an example of a system for preparing blends of dry powder cement according to certain aspects of the present disclosure.

FIG. 2 is a schematic illustration of an example of a dry powder mixing tank for blending dry powder cement according to certain aspects of the present disclosure.

FIG. 3 is a block diagram illustrating an example of a control system according to certain aspects of the present disclosure.

FIG. 4 is a flow chart illustrating an example of a method for blending dry powders according to one aspect of the present disclosure.

### DETAILED DESCRIPTION

Certain aspects and examples of the present disclosure are directed to systems for providing dried powder blends of a target consistency, e.g., cement batches of a homogeneous consistency. Such systems can include dry powder mixing tanks that can receive distinct powders (e.g., neat cement and various additives) in one end and eject a mixed powder blend from another end. The ejected mixed powder blend can flow past sensors that can detect the presence and amount of different substances in the flowing blend. Such information from the sensors can be used to determine the composition of the blend over any interval.

The blend can move from one location to another. For example, the blend can move from the dry powder mixing tank toward a cement truck or other receptacle for the blend. Changes or anomalies in the composition can be detected by comparing the composition at different intervals as the blend is moving. A lack of anomalies detected in the blend while the receptacle is being filled can indicate that the blend contained in the receptacle is substantially homogenous and likely to perform in a predictable and consistent manner. If any anomalies in the blend are detected, the portion of the blend corresponding to the anomaly can be diverted away from the receptacle by valves or other flow control mechanisms located downstream of the sensors. Diverting the portions of the blend corresponding to anomalies may provide a high degree of certainty that the entire non-diverted blend that is ultimately routed to the receptacle is homogenous. Any blend diverted away from the receptacle can be appropriately handled (e.g., by additional mixing, further additions of substance to attain a desired ratio, or some combination thereof) to minimize waste and ensure a quality product.

These illustrative examples are given to introduce the reader to the general subject matter discussed here and are not intended to limit the scope of the disclosed concepts. The following describes various additional aspects and examples with reference to the drawings in which like numerals indicate like elements, and directional descriptions are used to describe the illustrative aspects. Like the illustrative aspects, the numerals and directional descriptions included in the following should not be used to limit the present disclosure.

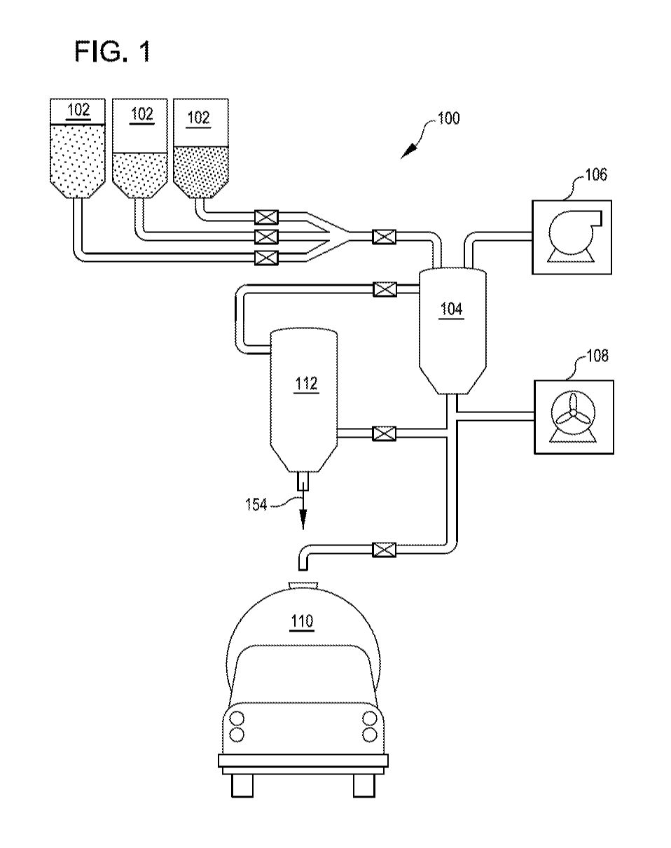

FIG. 1 schematically depicts an example of a system 100 for preparing blends of dry powder cement. Although the description of FIG. 1 focuses on blends of dry powder cement, the system 100 can be used for blending any other types of dry powders.

The system 100 can produce batches of blended cement powder. Any batch may have specific parameters corresponding to the batch. For example, a target consistency (e.g., composition within a tolerance) may be specified for a batch. As an illustrative example, a batch may have a designated composition of ninety-nine percent neat cement and one percent of a chemical additive, with a tolerance of one tenth of a percent. Neat cement and additive powders can be proportionately combined by the system 100 in respective amounts to attain a ratio of the powders corresponding to the designated composition. Mixing the combined powders can achieve a distribution of the appropriately proportioned powders throughout the blend so that any sample of the blend satisfies the parameters designated for the blend. For example, mixing can make a batch substantially homogenous, having substantially the same distribution of constituent components throughout the batch.

The system 100 includes storage tanks 102 and a dry powder mixing tank 104. Neat cement (or other) powder stored in the storage tanks 102 can be introduced into the dry powder mixing tank 104 and mixed with one or more types of additive powders in the dry powder mixing tank 104. A vacuum pump 106 or a blower 108 (or both) can provide air pressure variation for moving dry powder within the system 100, such as from one or more of the storage tanks 102 to the dry powder mixing tank 104 or away from the dry powder mixing tank 104. A blend of powders from the dry powder mixing tank 104 (e.g., cement mixed with additives) can be routed either to a carrier vehicle 110 (or other receptacle for storage or transport of the completed blend), or away from the carrier vehicle 110 for further processing of the blend, e.g., to a re-blend tank 112 for additional mixing to achieve a suitable distribution of the constituent powders in the blend.

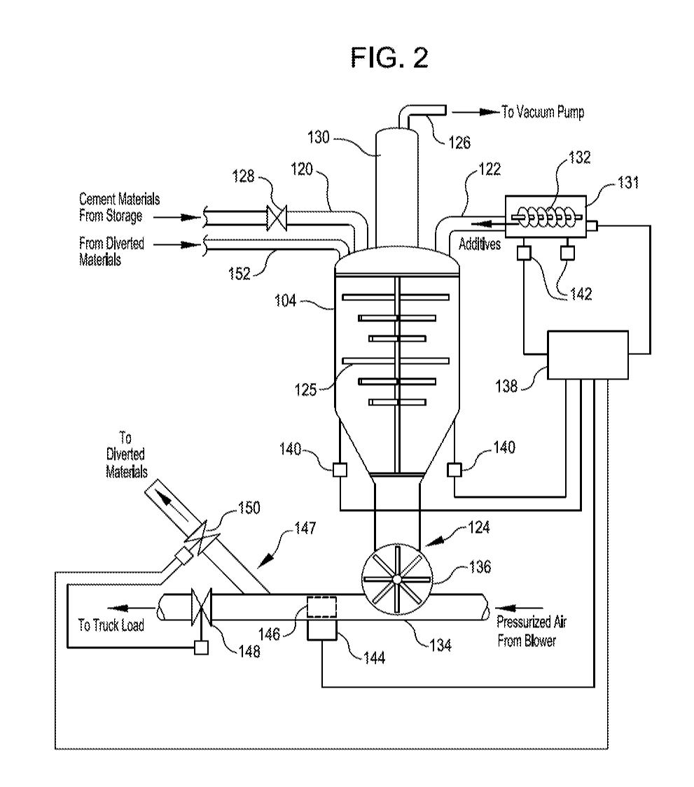

FIG. 2 is a schematic illustration of an example of a dry powder mixing tank 104 for blending dry powder cement according to certain aspects of the present disclosure. The dry powder mixing tank 104 can be associated with a first powder input 120, a second powder input 122, a powder output 124, a mixing structure 125, a vacuum line 126, an additive feeder 131, a conduit 134, a rotary feeder 136, a control system 138, load cells 140 and 142, and a detection device 144. Although the dry powder mixing tank 104 is depicted in FIG. 2 in association with all of these components, in some aspects, the dry powder mixing tank 104 is associated with a different combination of components (e.g., having fewer, more, or zero of any component; having a different arrangement of components; or having some combination of different numbers and arrangements of components).

The dry powder mixing tank 104 shown in FIG. 2 is coupled with the first powder input 120, the second powder input 122, and the powder output 124 via ports for each feature. In some aspects, neat cement is introduced into the dry powder mixing tank 104 by the first powder input 120, additives are introduced through the second powder input 122, and a resulting powder blend exits the dry powder mixing tank 104 by the powder output 124 (e.g., into the conduit 134).

The mixing structure 125 can be positioned within the dry powder mixing tank 104. The mixing structure 125 can facilitate mixing of powders introduced by the first powder input 120 and the second powder input 122. For example, the mixing structure 125 can include a series of mixing bars. The mixing bars can be arranged at different angles so that each bar is angled from another of the bars. Powder particles falling or otherwise moving through the dry powder mixing tank 104 may strike the bars and deflect at various angles, thereby randomizing the distribution of incoming powder particles and increasing an amount of mixing occurring in the dry powder mixing tank 104. In some aspects, the mixing bars are rotatable, which can cause additional randomizing and mixing. In some aspects, the mixing bars can be angled toward a common position such that any powder particles sliding down the mixing bar from a powder input (e.g., the first powder input 120 or the second powder input 122) will be directed into powder particles from another powder input to increase mixing of the powder particles. The mixing structure 125 can provide mixing to increase a likelihood that powders introduced in appropriate proportions are distributed sufficiently throughout a blend to satisfy parameters of the blend.

Any suitable mechanism may be used for moving dry powder with respect to the dry powder mixing tank 104. In one example, the vacuum pump 106 (FIG. 1) is in communication with the dry powder mixing tank 104 via the vacuum line 126 (FIG. 2) and provides suction to draw neat cement from a storage tank 102 and through the first powder input 120 into the dry powder mixing tank 104. An amount or rate of neat cement introduced into the dry powder mixing tank 104 can be adjustable, such as by controlling an amount of suction applied by the vacuum pump 106, by controlling a flow restriction device (e.g., valve 128) regulating the first powder input 120, or some combination thereof. A filter 130 positioned across the vacuum line 126 can prevent neat cement from reaching the vacuum pump 106 or leaving the dry powder mixing tank 104 through the vacuum line 126.

As another example, an auger 132 or other mechanical component of the additive feeder 131 can push or pull additive powder into the dry powder mixing tank 104 through the second powder input 122. An amount or rate of additive powder introduced into the dry powder mixing tank 104 can be adjusted by controlling the auger 132.

As a further example, the blower 108 (FIG. 1) can be in communication with the conduit 134 (FIG. 2) and provide air pressure to push powder from the powder output 124 and through the conduit 134. Additionally, although specific powder-moving mechanisms (e.g., vacuum pressure, mechanical motion, and blowing pressure) are respectively described and shown with respect to particular features in FIG. 2 (e.g., the first powder input 120, the second powder input 122, and the powder output 124), powder may be moved relative to any of these or other features using any other powder-moving mechanism.

In some aspects, the powder output 124 can include or be coupled with a rotary feeder 136. The rotary feeder 136 can transfer blended powder from the dry powder mixing tank 104 to the conduit 134. The rotary feeder 136 can provide a pressure barrier that allows a vacuum from the vacuum pump 106 to be used to move powder on one side of the rotary feeder 136 (e.g., in the dry powder mixing tank 104) without interfering with use of a blowing pressure from the blower 108 to move powder on an opposite side of the rotary feeder 136 (e.g., in the conduit 134). For example, powder moved into the dry powder mixing tank 104 by a continuous vacuum can be moved by the rotary feeder 136 into a continuous pressure (operating simultaneously with the continuous vacuum) that will carry the powder away through the conduit 134.

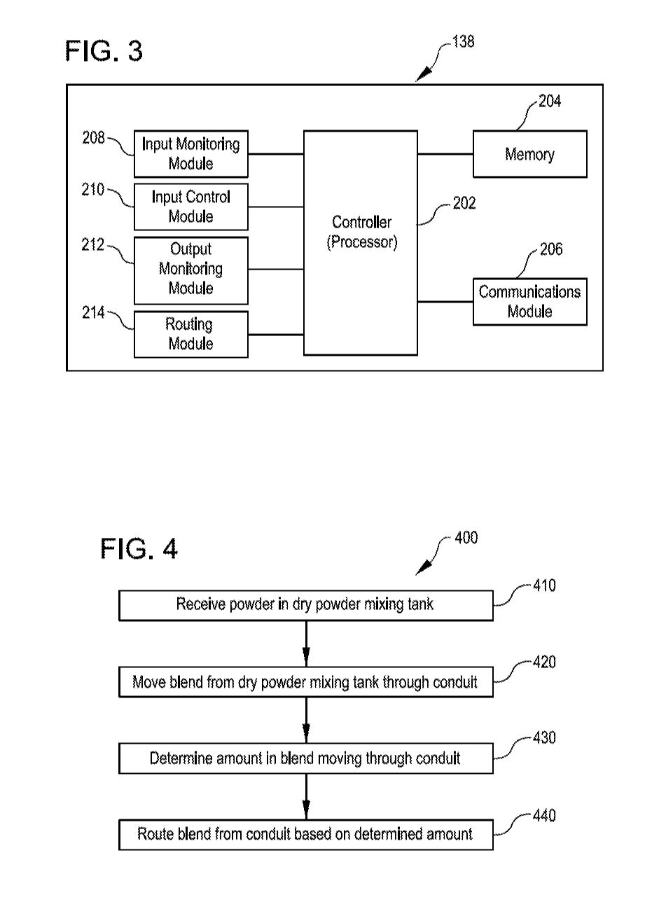

The control system 138 can include a processor device and a non-transitory computer-readable medium on which machine-readable instructions can be stored. Examples of non-transitory computer-readable medium include random access memory (RAM) and read-only memory (ROM). The processor device can execute the instructions to perform various actions, some of which are described herein. The actions can include, for example, determining amounts of powder entering or exiting the dry powder mixing tank 104, or controlling components to route portions of the blend output from the dry powder mixing tank 104. An illustrative example of the control system 138 is described below with respect to FIG. 3.

Various features associated with the dry powder mixing tank 104 can be in communication with the control system 138. For example, load cells 140 and 142 can be in communication with the control system 138. The load cells 140 and 142 can facilitate loss-in-weight metering. In an illustrative example, a first set of load cells 140 associated with the dry powder mixing tank 104 may provide the control system 138 with information about a total weight of the contents of the dry powder mixing tank 104. A second set of load cells 142 associated with the additive feeder 131 may provide information about a total weight of the contents of the additive feeder 131. A change in the weight of the contents of the additive feeder 131 can indicate an amount of additives that have been introduced into the dry powder mixing tank 104. The amount of introduced additives can be subtracted from the total weight of the contents of the dry powder mixing tank 104 to determine an amount of neat cement powder that has been introduced. The introduced amounts of neat cement and additive powders can be used to determine a ratio of the neat cement and the additive powders in the blend in the dry powder mixing tank 104. The control system 138 may control the first powder input 120 or the second powder input 122 (or both) and adjust the amounts of neat cement and additives added to the dry powder mixing tank 104, such as to adjust the ratio between neat cement and additive powders toward a designated blend ratio for a particular batch.

The control system 138 can be in communication with the detection device 144. The detection device 144 can be positioned proximate (e.g., adjacent, in, or around) a particular volume 146 of the conduit 134. The detection device 144 can obtain information about the presence and amount of different substances in the blend of powder passing from the powder output 124 and through the particular volume 146 of the conduit 134. For example, the detection device 144 can include at least one integrated computational element (commonly referred to as an “ICE”) capable of identifying electromagnetic radiation related to a characteristic of interest of a substance in a fluid (e.g., concentration of the substance in the fluid, particle size distribution of the substance, or the temperature of the substance). As an illustrative example, an ICE may detect the presence and amount of a substance in the powder using photometric detection (e.g., correlating an optical pattern and intensity of light shined through the powder with an optical fingerprint of a chemical identity of a known substance).

A composition of the powder blend passing through the particular volume 146 of the conduit 134 can be determined based on information from the detection device 144. For example, the control system 138 can compare information received from the detection device 144 about amounts of different substances present in the particular volume 146 to determine the relative proportions of the present substances. In an illustrative example, upon receiving data from the detection device 144, the control system 138 may determine that the composition of the powder blend passing through the particular volume 146 during a first one-second time interval is ninety-seven percent neat cement and one percent each of three different additives, and may determine that the composition during a second one-second time interval, is ninety-eight percent neat cement, one percent each of the first two additives, and zero percent of the third additive. The control system 138 can monitor the composition of the blend and perform actions based on the determined composition. In one example, the control system 138 may produce a record indicating the determined composition with respect to time, e.g., so that an operator may review the record to confirm that a batch of blended powder routed to a carrier vehicle 110 or other storage vessel was sufficiently consistent to fulfill a purpose for which the batch was made.

In some aspects, the system 100 includes components that can route or direct a powder blend based on a composition determined from information from the detection device 144. For example, the control system 138 can be in communication with a valve assembly 147 that includes one or more valves in the conduit 134. Although the valve assembly 147 is shown in FIG. 2 with two valves (i.e., a delivery valve 148 and a diversion valve 150), the valve assembly 147 may include a single valve or more than two valves. The control system 138 can control the valve assembly 147 to direct a powder blend from the dry powder mixing tank 104 toward a carrier vehicle 110 or other receptacle. Alternatively, the control system 138 can control the valve assembly 147 to direct a powder blend away from the carrier vehicle 110.

In an illustrative example, the control system 138 performs a comparison between a set of parameters for a batch and a determined composition of a powder blend passing through the particular volume 146. When the determined composition is within the parameters (e.g., within a specified tolerance from a specified composition), the control system 138 maintains the delivery valve 148 open and the diversion valve 150 closed to route the powder blend to the carrier vehicle 110. When the determined blend is outside of the parameters (e.g., outside a specified tolerance from a specified composition for at least a threshold amount of time), the control system 138 shuts the delivery valve 148 and opens the diversion valve 150 to route the powder away from the carrier vehicle 110.

In some aspects, diverted powder blends can be routed to a re-blend tank 112 (FIG. 1). The powder blends collected in the re-blend tank 112 may be further mixed in the re-blend tank 112, en route to the re-blend tank 112, during transfer from the re-blend tank 112, or some combination thereof. Mixing the diverted powder blend may distribute powder particles within the blend sufficiently to meet the parameters for a batch. In an illustrative example, ninety-nine parts neat cement and one part additive may be input into the dry powder mixing tank 104 to provide an appropriate ratio of substances for a batch with a designated composition of ninety-nine percent neat cement. Although the overall ratio of substances is correct in the dry powder mixing tank 104, the resulting distribution of the additive within the neat cement may be non-uniform in the blend ejected via the powder output 124. During operation of the system 100 in this illustrative example, the control system 138 accordingly routes all intervals of the blend with a detected composition of ninety-nine percent through the delivery valve 148 and diverts all intervals of the blend with a composition over or under ninety-nine percent through the diversion valve 150 to the re-blend tank 112. Although some of the diverted powder was over ninety-nine percent and some was under ninety-nine percent, the final ratio of the powder collected in the re-blend tank 112 is likely to be approximately ninety-nine percent neat cement due to the initial proportions of powders introduced into the dry powder mixing tank 104. The diverted powder collected in the re-blend tank 112 may satisfy the parameters for the batch upon undergoing mixing or re-blending that is sufficient to distribute the additive evenly through the neat cement (e.g., circulating the powder within the re-blend tank 112, or transferring the powder between the re-blend tank 112 and other tanks). The re-blended powder blend satisfying the parameters of the batch may be routed from the re-blend tank 112 to the carrier vehicle 110 (as at 154 in FIG. 1).

In some aspects, diverted powder blends can be routed back into the dry powder mixing tank 104 via a mixed powder input 152 (e.g., with or without traveling through a re-blend tank 112). Routing the diverted powder blends into the dry powder mixing tank 104 can facilitate additional mixing of the blend, which may improve the overall distribution of different types of particles throughout the blend. In some aspects, additional neat cement or additive powders can be added to the re-blend tank 112 or the dry powder mixing tank 104 to adjust ratios of substances in the incoming diverted powder blend.

In some aspects, a detection device 144 can be implemented elsewhere in the system 100, e.g., to provide additional information about a composition or amount of powder moving past a specific position. For example, detection devices 144 coupled with the first powder input 120, the second powder input 122, the mixed powder input 152, or any combination thereof may provide information that can be used to determine amounts of different powder types that have been introduced into the dry powder mixing tank 104 (e.g., in addition to or as an alternative to obtaining such information from the load cells 140 and 142). In some aspects, such information may be used to determine appropriate amounts of neat cement or additives to be added to the dry powder mixing tank 104 to achieve a desired ratio of substances for a batch of blended cement.

FIG. 3 is a block diagram illustrating an example of a control system 138 according to certain aspects of the present disclosure. The control system 138 can include a controller or processor 202, memory 204, a communications module 206, an input monitoring module 208, an input control module 210, an output monitoring module 212, and a routing module 214. The control system 138 can include any appropriate combination of hardware and software suitable to provide the functionality of these components. Although the control system 138 shown in FIG. 3 includes all of these components, in some aspects, components may be omitted or part of distinct control systems 138. For example, the input control module 210 and the output monitoring module 212 may be associated with different processors 202 of different control systems 138 that may or may not communicate with each other via respective communications modules 206.

The memory 204 (e.g., RAM or ROM) can store machine-readable instructions accessible by the processor 202. The processor 202 can execute the instructions to perform various actions, such as accessing or operating the other various components of the control system 138. The memory 204 additionally or alternatively can store data to be organized and analyzed.

The communications module 206 can communicate information to or from the processor 202, such as from components described above with respect to FIGS. 1 and 2. In some aspects, the communications module 206 can communicate commands or instructions from the processor 202 to control the operation of other components.

The input monitoring module 208 can monitor the powder input into the dry powder mixing tank 104. For example, the input monitoring module 208 may utilize information related to components such as the load cells 140, 142, the additive feeder 131, or the valve 128 regulating the first powder input 120 of FIG. 1 to determine amounts of powders that have been added to the dry powder mixing tank 104. In some aspects, the input monitoring module 208 of the control system 138 may receive first information from a first set of load cells and second information from a second set of load cells to determine an amount of contents that has been introduced from a component not coupled with load cells. For example, the input monitoring module 208 may use information from load cells 140 coupled with the dry powder mixing tank 104 and information from load cells 142 coupled with the additive feeder 131 to determine an amount of neat cement added to the dry powder mixing tank 104 from a first powder input 120 that is not equipped with load cells.

The input control module 210 can control the powder input into the dry powder mixing tank 104. For example, the input control module 210 may control components such as the additive feeder 131 (e.g., the auger 132), the valve 128 restricting the first powder input 120, the vacuum pump 106, the blower 108, the rotary feeder 136, or other components associated with the dry powder mixing tank 104 to control amounts of different types of powders (e.g., neat cement and additives) that are added to or present in the dry powder mixing tank 104. In some aspects, the input control module 210 may control the powder input into the dry powder mixing tank 104 in response to information from the detection device 144.

The output monitoring module 212 can monitor powder that is output from the dry powder mixing tank 104. For example, the output monitoring module 212 may use information from components such as the detection device 144, the rotary feeder 136, the vacuum pump 106, or the blower 108 to determine information about the blend ejected from the dry powder mixing tank 104, e.g. amounts of different substances in the blend or speed of the blend. The output monitoring module 212 may compare the output powder with parameters or tolerances set for a particular batch.

The routing module 214 can determine the manner in which the blend from the dry powder mixing tank 104 is to be routed. For example, the routing module 214 may control the valve assembly to route the blend to a carrier vehicle 110 or other storage vessel, a re-blend tank 112, or the dry powder mixing tank 104. In some aspects, the routing module 214 may route the blend based on information from the output monitoring module 212, such as based on the indications that the blend satisfies or fails parameters tolerances set for the blend.

FIG. 4 is a flow chart illustrating an example of a method 400 for blending dry powders according to one aspect of the present disclosure. The method 400 can utilize components of a system as described herein, such as the system 100 described above with respect to FIGS. 1-2 or variations thereof.

In block 410, powder is received in a dry powder mixing tank. The powder can include a first powder and a second powder. For example, neat cement can be introduced via a port for a first powder input 120 and additives can be added through a port for a second powder input 122. In some aspects, a vacuum pump 106 or a blower 108 can move the powder into the dry powder mixing tank 104, such as through variations of air pressure provided by the vacuum pump 106 or the blower 108.

In block 420, a blend from the dry powder mixing tank can be moved through a conduit. For example, a mixed blend of cement may output from the dry powder mixing tank 104 and moved through the conduit 134. In some aspects, a vacuum pump 106 or a blower 108 can move the powder through the conduit 134. For example, the vacuum pump 106 may move powder into the dry powder mixing tank 104 and the blower 108 may move powder through the conduit 134 or vice versa. In some aspects, the blower 108 and the vacuum pump 106 may be operated simultaneously. For example, a continuous flow of powder into and out of the dry powder mixing tank 104 may be provided by the blower 108, the rotary feeder 136, and the vacuum pump 106.

In block 430, an amount in the blend moving through the conduit can be determined. For example, an amount of neat cement, an amount of one or more additives, or an overall composition of the blend in the conduit 134 may be detected by the detection device 144.

In block 440, the blend from the conduit can be routed based on the determined amount. For example, the blend from the conduit 134 may be routed based on the amount of neat cement, the amount of the one or more additives, or the overall composition of the blend in the conduit 134 detected by the detection device 144. In some aspects, the blend is routed by a valve assembly 147. In some aspects, the blend can be routed to a carrier vehicle 110 or a storage receptacle in response to the determined amount being within parameters, such as within a set tolerance. In some aspects, the blend can be routed by diverting the blend of powder away from the carrier vehicle 110 or the storage receptacle in response to the determined amount being outside the parameters or set tolerance. In some aspects, routing the blend based on the determined amount includes routing the blend so as to treat the diverted blend by at least one of mixing the diverted blend or adding powder to the diverted blend and routing the treated diverted blend to the carrier vehicle 110 or the storage receptacle.

In some aspects, a tool, a system. or a method is provided according to one or more of the following examples or according to some combination of the elements thereof. In some aspects, a tool or a system described in one or more of these examples can be utilized to perform a method described in one of the other examples.

### Example #1

Provided can be a system comprising: (A) a dry powder mixing tank having (i) at least one input port for receiving first dry powder that includes a first substance and for receiving second dry powder that includes a second substance having a chemical composition different from the first substance, and (ii) an output port for outputting a blend of the first dry powder and the second dry powder into a conduit; (B) a detection device proximate the conduit and arranged for detecting amounts of the first substance and the second substance in the blend in the conduit; and (C) at least one valve controllable to route the blend in the conduit in response to information from the detection device about an amount of the first substance or the second substance in the blend.

### Example #2

Provided can be the system of Example #1, wherein the first dry powder comprises cement, and wherein the second dry powder comprises an additive for adjusting a characteristic of the cement.

### Example #3

Provided can be the system of Example #1 (or any of Examples #1-2), wherein the at least one input port comprises (i) a first input port for receiving the first dry powder that includes the first substance, and (ii) a second input port for receiving the second dry powder that includes the second substance having a chemical composition different from the first substance.

### Example #4

Provided can be the system of Example #3 (or any of Examples #1-3), further comprising: (A) a first set of load cells coupled with the dry powder mixing tank; (B) a second set of load cells coupled with one of (i) a first dry powder source coupled with the first input port or (ii) a second dry powder source coupled with the second input port; and (C) a control system communicatively coupled with the first set of load cells and the second set of load cells, the control system comprising a processor and a memory device coupled with the processor, the memory device containing a set of instructions that, when executed by the processor, cause the processor to: (i) receive first information from the first set of load cells about a first weight of contents in the dry powder mixing tank; (ii) receive second information from the second set of load cells about a second weight of contents introduced from the one of the first dry powder source or the second dry powder source coupled with the second set of load cells; and (iii) determine, based on the first information and the second information, an amount of contents that has been introduced from whichever of the first dry powder source or the second dry powder source that is not coupled with the second set of load cells.

### Example #5

Provided can be the system of Example #1 (or any of Examples #1-4), further comprising a plurality of mixing bars arranged inside the dry powder mixing tank so that each mixing bar is angled from another mixing bar.

### Example #6

Provided can be the system of Example #1 (or any of Examples #1-5), further comprising a plurality of rotatable mixing bars arranged inside the dry powder mixing tank.

### Example #7

Provided can be the system of Example #1 (or any of Examples #1-6), further comprising: (A) a rotary feeder positioned for moving the blend of the first dry powder and the second dry powder from the output port into the conduit; (B) a vacuum pump in communication for moving dry powder relative to one of the dry powder mixing tank or the conduit; and (C) a blower in communication for moving dry powder relative to the other of the dry powder mixing tank or the conduit.

### Example #8

Provided can be the system of Example #1 (or any of Examples #1-7), wherein the at least one valve is controllable to divert the blend in the conduit in response to information from the detection device indicating that the amount of the first substance or the second substance in the blend is outside set parameters for the amount.

### Example #9

Provided can be the system of Example #8 (or any of Examples #1-8), further comprising a re-blend tank downstream of the at least one valve, wherein the at least one valve is controllable so as to divert the blend in the conduit to the re-blend tank.

### Example #10

Provided can be the system of Example #8 (or any of Examples #1-9), wherein the at least one valve is controllable so as to divert the blend in the conduit to the dry powder mixing tank.

### Example #11

Provided can be a system (or the system of any of Examples #1-10) comprising: (A) a dry powder mixing tank having at least one input port for receiving dry powders; (B) a rotary feeder arranged for moving a blend of powders out of the dry powder mixing tank; (C) a conduit arranged for receiving the blend of powders from the rotary feeder; (D) a vacuum pump in communication for moving dry powder relative to one of the dry powder mixing tank or the conduit; and (E) a blower in communication for moving dry powder relative to the other of the dry powder mixing tank or the conduit.

### Example #12

Provided can be the system of Example #11 (or any of Examples #1-11), further comprising a detection device arranged for detecting amounts of different substances in the blend of powders passing through the conduit.

### Example #13

Provided can be the system of Example #12 (or any of Examples #1-12), further comprising at least one valve controllable to route powder in response to information from the detection device about an amount of at least one substance in the blend of powders passing through the conduit.

### Example #14

Provided can be a method comprising: (A) receiving a first powder and a second powder into a dry powder mixing tank; (B) moving a blend of powder from the dry powder mixing tank through a conduit; (C) determining an amount of the first powder or the second powder in the blend of powder moving through the conduit; and (D) routing, by a valve assembly, the blend of powder from the conduit based on the determined amount of the first powder or the second powder in the blend of powder moving through the conduit.

### Example #15

Provided can be the method of Example #14, wherein the first powder comprises cement, and wherein the second powder comprises an additive for adjusting a characteristic of the cement.

### Example #16

Provided can be the method of Example #14 (or any of Examples #14-15), wherein routing, by a valve assembly, the blend of powder from the conduit based on the determined amount of the first powder or the second powder in the blend of powder moving through the conduit comprises routing the blend of powder to a carrier vehicle or a storage receptacle in response to the determined amount being within a set tolerance.

### Example #17

Provided can be the method of Example #16 (or any of Examples #14-16), wherein routing, by a valve assembly, the blend of powder from the conduit based on the determined amount of the first powder or the second powder in the blend of powder moving through the conduit further comprises diverting the blend of powder away from the carrier vehicle or the storage receptacle in response to the determined amount being outside the set tolerance.

### Example #18

Provided can be the method of Example #17 (or any of Examples #14-17), further comprising: (A) treating the diverted blend by at least one of mixing the diverted blend or adding powder to the diverted blend; and (B) routing the treated diverted blend to the carrier vehicle or the storage receptacle.

### Example #19

Provided can be the method of Example #14 (or any of Examples #14-18), wherein a vacuum pump is used for moving powder into the dry powder mixing tank and a blower is used for moving powder through the conduit, or wherein a blower is used for moving powder into the dry powder mixing tank and a vacuum pump is used for moving powder through the conduit.

### Example #20

Provided can be the method of Example #19 (or any of Examples #14-19), wherein the vacuum pump and the blower are operated simultaneously.

The foregoing description, including illustrated aspects and examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of this disclosure.

What is claimed is:

1. A system comprising:
a dry powder mixing tank having (i) at least one input port for receiving first dry powder that includes a first substance and for receiving second dry powder that includes a second substance having a chemical composition different from the first substance, and (ii) an output port for outputting a blend of the first dry powder and the second dry powder into a conduit;
a detection device proximate the conduit and arranged for detecting amounts of the first substance and the second substance in the blend in the conduit; and
at least one valve controllable to route the blend in the conduit in response to information from the detection device about an amount of the first substance or the second substance in the blend.

2. The system of claim 1, wherein the first dry powder comprises cement, and wherein the second dry powder comprises an additive for adjusting a characteristic of the cement.

3. The system of claim 1, wherein the at least one input port comprises (i) a first input port for receiving the first dry powder that includes the first substance, and (ii) a second input port for receiving the second dry powder that includes the second substance having a chemical composition different from the first substance.

4. The system of claim 3, further comprising:
a first set of load cells coupled with the dry powder mixing tank;
a second set of load cells coupled with one of (i) a first dry powder source coupled with the first input port or (ii) a second dry powder source coupled with the second input port; and
a control system communicatively coupled with the first set of load cells and the second set of load cells, the control system comprising a processor and a memory device coupled with the processor, the memory device containing a set of instructions that, when executed by the processor, cause the processor to:
receive first information from the first set of load cells about a first weight of contents in the dry powder mixing tank;
receive second information from the second set of load cells about a second weight of contents introduced from the one of the first dry powder source or the second dry powder source coupled with the second set of load cells; and
determine, based on the first information and the second information, an amount of contents that has been introduced from whichever of the first dry powder source or the second dry powder source that is not coupled with the second set of load cells.

5. The system of claim 1, further comprising a plurality of mixing bars arranged inside the dry powder mixing tank so that each mixing bar is angled from another mixing bar.

6. The system of claim 1, further comprising a plurality of rotatable mixing bars arranged inside the dry powder mixing tank.

7. The system of claim 1, further comprising:
a rotary feeder positioned for moving the blend of the first dry powder and the second dry powder from the output port into the conduit;
a vacuum pump in communication for moving dry powder relative to one of the dry powder mixing tank or the conduit; and
a blower in communication for moving dry powder relative to the other of the dry powder mixing tank or the conduit.

8. The system of claim 1, wherein the at least one valve is controllable to divert the blend in the conduit in response to information from the detection device indicating that the amount of the first substance or the second substance in the blend is outside set parameters for the amount.

9. The system of claim 8, further comprising a re-blend tank downstream of the at least one valve, wherein the at least one valve is controllable so as to divert the blend in the conduit to the re-blend tank.

10. The system of claim 8, wherein the at least one valve is controllable so as to divert the blend in the conduit to the dry powder mixing tank.

11. A system comprising:
a dry powder mixing tank having at least one input port for receiving dry powders;
a rotary feeder arranged for moving a blend of powders out of the dry powder mixing tank;
a conduit arranged for receiving the blend of powders from the rotary feeder;
a vacuum pump in communication for moving dry powder relative to one of the dry powder mixing tank or the conduit; and
a blower in communication for moving dry powder relative to the other of the dry powder mixing tank or the conduit.

12. The system of claim 11, further comprising a detection device arranged for detecting amounts of different substances in the blend of powders passing through the conduit.

13. The system of claim 12, further comprising at least one valve controllable to route powder in response to information from the detection device about an amount of at least one substance in the blend of powders passing through the conduit.

14. A method comprising:
receiving a first powder and a second powder into a dry powder mixing tank;
moving a blend of powder from the dry powder mixing tank through a conduit;
determining an amount of the first powder or the second powder in the blend of powder moving through the conduit; and
routing, by a valve assembly, the blend of powder from the conduit based on the determined amount of the first powder or the second powder in the blend of powder moving through the conduit.

15. The method of claim 14, wherein the first powder comprises cement, and wherein the second powder comprises an additive for adjusting a characteristic of the cement.

16. The method of claim 14, wherein routing, by a valve assembly, the blend of powder from the conduit based on the determined amount of the first powder or the second powder in the blend of powder moving through the conduit comprises routing the blend of powder to a carrier vehicle or a storage receptacle in response to the determined amount being within a set tolerance.

17. The method of claim 16, wherein routing, by a valve assembly, the blend of powder from the conduit based on the determined amount of the first powder or the second powder in the blend of powder moving through the conduit further comprises diverting the blend of powder away from the carrier vehicle or the storage receptacle in response to the determined amount being outside the set tolerance.

18. The method of claim 17, further comprising:
treating the diverted blend by at least one of mixing the diverted blend or adding powder to the diverted blend; and
routing the treated diverted blend to the carrier vehicle or the storage receptacle.

19. The method of claim 14, wherein a vacuum pump is used for moving powder into the dry powder mixing tank and a blower is used for moving powder through the conduit, or
wherein a blower is used for moving powder into the dry powder mixing tank and a vacuum pump is used for moving powder through the conduit.

20. The method of claim 19, wherein the vacuum pump and the blower are operated simultaneously.
